(19) United States
(12) Patent Application Publication
(10) Pub. No.: US 2011/0283337 A1
(43) Pub. Date: Nov. 17, 2011

(54) METHOD AND SYSTEM FOR AUTHENTICATING NETWORK NODES OF A PEER-TO-PEER NETWORK

(76) Inventor: Rainer Schatzmayr, Bonn (DE)

(21) Appl. No.: 13/143,190

(22) PCT Filed: Dec. 15, 2009
(86) PCT No.: PCT/EP2009/008990

§ 371 Date: Jul. 4, 2011

(30) Foreign Application Priority Data
Jan. 9, 2009 (DE) 10 2009 004 490.6

(51) Int. Cl. G06F 21/00; G06F 15/16

(52) U.S. Cl. 726/3

(57) ABSTRACT

This invention relates to system and a method for authentication of a network node (2) which can be inserted into a peer-to-peer network (1) and to which a unique identifier is assigned which, when access to the network node (2) is desired is transmitted to an authentication means (5) connected to the network (1) and is checked by the means, the network node (2) being inserted into the network (1) when the check is successful. Authentication is done by a land mobile network operator (4), the authentication means (5) being part of the land mobile network of the mobile network operator (4) and the identifier being validated by the authentication module (AM) of the network node (2) and being transmitted to the authentication means (5).

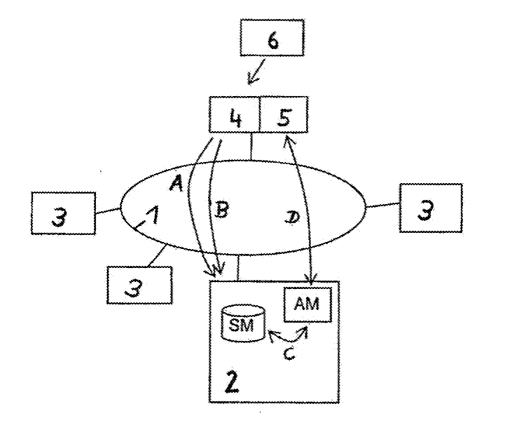

This invention relates to a method and system for authentication of a network node which can be inserted into a peer-to-peer network and to which a unique identifier is assigned which, when access of the network node is desired, is transmitted to an authentication means connected to the network and is checked by the means, the network node being inserted into the network when the check is successful.

Peer-to-peer (P2P) networks are those networks in which computers with equal access, called peers and designated network nodes here, are linked to one another. They enable communications among “coordinated” network nodes or those “with equal access”. Network nodes in a peer-to-peer network can both claim services and can thus be used as working stations and can offer services, i.e. can assume tasks in the network. The peer-to-peer network architecture thus constitutes the counterpart to the client server network architecture, the physical network structure being based on conventional networks such as intranets (local area networks, LAN) or the Internet (world area networks, WANs). Peer-to-peer architectures are used especially for data exchange, since each network node can access certain released data of another network node. This is also called “file sharing”.

In a peer-to-peer network each network node is assigned a unique identifier which enables identification in the network. Some peer-to-peer networks administer the issuance of new identifiers and authentication of the network nodes using the identifier by a central server. As soon as a network node would like to be incorporated into the peer-to-peer network, a corresponding unique identifier is issued. Generally a user after installation of a peer-to-peer network is requested to create a new identifier and an associated password in order to acquire access to the peer-to-peer network. Alternatively, having the identifier and password delivered to the user via E-mail is also known.

Provided the user would like to acquire access to the network, he makes available his identifier and password to an authentication server which validates the identity of the user, i.e. of the network node by which the user would like to acquire access. The user is only authorized to communicate over the network when authentication has proceeded successfully. This authentication mechanism is not secure and does not ensure compatibility to other peer-to-peer networks.

Peer-to-peer networks can be used to set up telephone calls. A peer-to-peer telephone call between two or more network nodes can only be established when the contact/contacts of the communications partners are known, for example in the form of an Internet address (IP address, Internet protocol) or a distinguishable name, for example in the form of an E-mail address such as me@myself.com. The use of peer-to-peer technology for telephone services is based on standard identifiers, i.e. on identifiers which are unique within the network. These identifiers can be used to find the communications partner (contact) within the network. The identifiers have a comparatively complex form. The form influences the effectiveness and the structure of the routing mechanisms within a peer-to-peer based telephone network. For example, numerous distributed hash tables (DHT) use 160 bit addresses in order to define a uniform end point, i.e. to find data objects or nodes in a peer-to-peer network.

The object of the invention is therefore to make available a simple and effective method for authentication of a network node which can be inserted into a peer-to-peer network and which satisfies high security requirements and enables compatibility of other peer-to-peer networks.

This object is achieved by the features of the method as claimed in claim 1 and by a system with the features of claim 7. Advantageous developments of the invention are formulated in the respective dependent claims and are detailed below.

As claimed in the invention, a method is proposed for authentication of a network node which can be inserted into a peer-to-peer network and to which a unique identifier is assigned which when access to the network node is desired is transmitted to an authentication means connected to the network and is checked by the means so that the network node is inserted into the network when the check is successful, authentication being carried out by a land mobile network operator, authentication being part of the land mobile network of a mobile network operator, the authentication means being part of the land mobile network of the mobile network operator and the identifier being validated by an authentication module of the network node and being transmitted to the authentication means.

The basic idea of this invention is to use the infrastructure of a land mobile network for authentication of the network node of a peer-to-peer network in order to identify the network node relative to the network and relative to the other network nodes and to confirm its identity.

Preferably the identifier can be a cellular subscriber number. The cellular subscriber number, also called a mobile subscriber integrated services digital network number (MSISDN), constitutes a unique, established identifier with which a user can be reliably and securely identified relative to others. This identifier consists solely of numbers between 0 and 9 and ensures prompt and efficient authentication.

The identifier can be kept in a separate storage module which is made available by the cellular provider or a peer-to-peer network provider and is connected to the network node. The storage module is a storage unit which is separate from the conventional hard disk storage, main memory or temporary buffer of the network node. It can be made in the form of a chip, for example as a SIM (subscriber identification module) card, USDVI (universal subscriber identification module) or as a smartcard. A corresponding reading means for reading of data stored on the storage module can be integrated in the network node or can be connected to the network node via a cable. The identifier is thus stored locally at the user, so that a maximum of security can be achieved. Outside access to the peer-to-peer network alone based on knowledge of the access data can thus be avoided.

If the network node would like to communicate with another network node and would like to be incorporated into the network for this purpose, the identifier of the network can be transmitted via the land mobile network or the peer-to-peer network to the authentication means which then authenticates the network node.

The identifier can be made available by the land mobile network provider. Alternatively the identifier can be made available by a peer-to-peer service provider which then makes the identifier available to the land mobile network operator.

The identifier which has been made available can be transmitted to the network node by way of the land mobile network and can be stored there in the storage module. Alternatively the identifier can also be stored by the mobile network operator directly on the storage module and along with the storage module can be made available to the network node.

Furthermore a system is proposed which comprises a peer-to-peer network, a network node which can be inserted into the network and to which a unique identifier is assigned, and with an authentication means which is connected to the network, and the identifier can be transmitted to the authentication means when access to the network node is requested and can be checked by the means, the authentication means being part of a land mobile network of a mobile network operator and the network node having an authentication module for communication with the authentication means.

The network node, as already described, can have a separate storage module which is connected to the authentication module and in which the identifier is or can be stored.

The storage module can be a SBVl card, USIM card, a TPM (trusted platform module) chip or a smartcard.

The invention is detailed below using one exemplary embodiment and the attached FIGURE.

The FIGURE shows a schematic representation of the system for executing the method as claimed in the invention. It comprises a peer-to-peer network 1 with several network nodes 3 and another network node 2 which can be inserted into the network and to which a unique identifier stored in the storage module SM is assigned and which has an authentication module AM for communication with an authentication means 5. The authentication means 5 is connected to the network 1 via a corresponding interface and is part of the land mobile network of a mobile network operator 4.

In peer-to-peer networks the use of identifiers for their identification relative to the network and the other network nodes is a special challenge. An identifier must be made available and authenticated by a reliable authority, a so-called “trusted identity provider”, so that a reliable connection between the network nodes can be established. By using the infrastructure of a land mobile network including the SIM card or a chip such as a “trusted platform module” and the authentication mechanisms of a cellular terminal and of the land mobile network, this can be made available easily and effectively.

Land mobile networks such as GSM (global system for mobile communications) networks have an especially secure approach to authentication of cellular subscribers. The identifier of the users is their respective MSISDN, i.e. their cellular subscriber numbers with which they can be uniquely identified worldwide. The network operators of these land mobile networks make available identifiers together with the SIM card. In addition the SIM cards contain a key which is used for authentication of the identifier which was made available with the SIM card. The SIM card is recognized and established as a reliable mechanism for identification and authentication of users relative to the telecommunications network.

The identifier for a network node 2 as claimed in the invention is designed either by the mobile network operator 4 or by an external peer-to-peer service provider 6. Provided the identifier is designed by the peer-to-peer service provider 6, it is sent to the mobile network operator 4.

After designing the identifier it is made available to the network node 2 so that it can be used for identification of the network node 2 in the peer-to-peer network 1. Only an authorized identifier can be used for identification of network nodes 2 which would like to communicate with other network nodes 3.

The identifier can be made available in different ways. The first approach is labeled with an arrow A in the FIGURE and comprises the storage of the identifier as an additional parameter on a new storage module SM which is then physically sent to the network node 2. Another approach is labeled with an arrow B in the FIGURE and comprises the transmission of the identifier via the land mobile network of the mobile network provider 4 to the network node 2. The latter then stores the identifier in the storage module SM. The storage module for network node identifier can be for example a SIM card or a chipset such as a TPM “trusted platform module”. Provided that a user would like to communicate with another user of the peer-to-peer network 1, the network node 2 which he is using must be incorporated into the network 1. One network node 2 is identified by its identifier which is made available to it, as described above.

In order to be inserted into the network 1, the network node 2 must be identified relative to the authentication infrastructure of the land mobile network operator 4.

This can take place by re-use of the authentication mechanisms of the mobile network operator 4.

The authentication mechanisms of the mobile network operator 4 are used to validate the identifier stored in the storage module SM, i.e. to check its validity. This takes place by the network node 2 by means of the authentication module AM, in the FIGURE identified with the arrow C. Validation is done by using the authentication mechanisms under the control of the mobile network operator 4. These mechanisms use the authentication module AM which is contained as claimed in the invention in each network node 2, 3. The authentication module AM carries out authentication of the identifier or of the network node 2 by its communicating with the central authentication means 5 of the authentication infrastructure of the land mobile network operator 4. This is shown in the FIGURE by the arrow D.

When the authentication procedure is successful, the network node 2 is correctly inserted into the peer-to-peer network 1 and can establish contacts to other network nodes 3. When the authentication conversely fails, the network node 2 is not authorized to communicate with other network nodes 3 within the network 1.

1-9. (canceled)

10. A method of authenticating a network node that can be inserted into a peer-to-peer network and to which a unique identifier is assigned that, when access to the network node is desired, is transmitted to an authentication means connected to the network and is checked by the means, wherein
the network node is inserted into the network when the check is successful,
authentication is done by a land mobile network operator,
the authentication means is part of the land mobile to network of the mobile network operator,
the identifier is kept in a separate storage module that is a SIM card, USIM card, a TPM chip or a smartcard that is made available by the mobile network provider or a peer-to-peer network provider and is connected to the network node, and
an authentication module carries out authentication of the network node by communicating its identifier with the central authentication means of the authentication infrastructure of the land mobile network operator.

11. The method defined in claim 10, wherein a cellular subscriber number is used as the identifier.

12. The method defined in claim 10, wherein the identifier is transmitted from the network node over the land mobile network or the peer-to-peer network to the authentication means.

13. The method defined in claim 10, wherein the identifier is transmitted to the network node to make it available over the land mobile network and is stored in the node in the storage module.

14. In a system comprising
a peer-to-peer network,
a network node that can be inserted into the network and to which a unique identifier is assigned, and
an authentication means that is connected to the network, and the identifier can be transmitted to the authentication means when access is requested and can be checked by the means, the improvement wherein
the authentication means is part of a land mobile network of a mobile network operator,
the network node has an authentication module for communication with the authentication means,
the network node has a separate storage module that is connected to the authentication module and in which the identifier is or can be stored, and
the storage module is a SM card, USIM card, a TPM chip or a smartcard.
